(19) United States
(12) Patent Application Publication
(10) Pub. No.: US 2026/0129097 A1
(43) Pub. Date: May 7, 2026

(54) IOT DEVICE CONTROL SYSTEM BASED ON SEARCHING FOR IMAGE

(71) Applicant: SLmedia Co., Ltd, Daegu (KR)

(72) Inventors: Yongjin Shin, Daegu (KR); Koungbin Kim, Daegu (KR)

(21) Appl. No.: 18/945,410

(22) Filed: Nov. 12, 2024

(30) Foreign Application Priority Data
Nov. 7, 2024 (KR) 10-2024-0156688

(51) Int. Cl. H04L 67/12; G06F 16/532

(52) U.S. Cl. CPC H04L 67/12; G06F 16/532

(57) ABSTRACT

Proposed is an IoT device control system. The IoT device control system, which has an IoT server, a local computer, and IoT devices networked through a router, includes a local computer having an operating system and one or more application programs installed therein, and an IoT server configured to receive a predetermined mode command which defines operating situations of the local computer and an IoT device and to transmit a control command to the local computer and the IoT device so that the local computer and the IoT device are executed as defined in the received mode command, and the IoT device includes one or more IoT devices driven by the control command received from the IoT server.

### CROSS REFERENCE TO RELATED APPLICATION

The present application claims priority to Korean Patent Application No. 10-2024-0156688, filed November 7, 2024, the entire contents of which are incorporated herein for all purposes by this reference.

### BACKGROUND OF THE INVENTION

### Field of the Invention

The present disclosure relates generally to an IoT device control system based on searching for an image. More particularly, the present disclosure relates to an IoT device control system based on searching for an image which enables an IoT server networked with a local computer and an IoT device through a router to recognize and control the situation of the local computer by searching for a screen image of the local computer, thereby preventing local information from being leaked to a separate external cloud server to be safe in terms of security, and operating independently of the external cloud server to enable more stable operation.

### Description of the Related Art

In general, IoT (Internet of Things) refers to intelligent information and communication technology or services that enable communication between people and things and between things by providing network connections to various things on the basis of the Internet.

As this IoT technology has developed, it has become possible to comprehensively control peripheral IoT devices connected to a network along with the execution of a specific application program installed on a local computer.

FIG. 1 is a drawing illustrating an IoT device control system that is linked with a conventional external cloud server.

The following description will be made with reference to FIG. 1.

A local computer has an operating system and a plurality of application programs installed.

When an application program is executed, it is necessary to control various IoT devices according to the execution of the application program.

For example, when a golf simulation program is executed, a lighting device, a heating and cooling device, a beam projector, etc. are controlled according to the progress of the program.

To control IoT devices, an IoT server needs information about the current status of the local computer and the execution status of the application program.

Typically, a company that develops the application program and a company that develops the IoT server that comprehensively controls the local computer and IoT devices are different from each other.

Therefore, the company that develops the IoT server obtains the cooperation of the company that develops the application program and receives the situation information of the application program to recognize the situations of the local computer and the application program.

Conventionally, as illustrated in FIG. 1, a local computer and an IoT device are connected to an external cloud server through the Internet, and the current status information of the local computer and an application program is transmitted to the external cloud server.

That is, the status information of the application program of the local computer and the status information of the IoT device are disclosed to the outside in real time.

In addition, the IoT server is connected to the external cloud server, receives current situation information of the local computer and application program to recognize the current situation, and then controls the local computer and IoT device.

When a network is formed in this manner, the situation information of the local computer and IoT device is exposed to the outside, which causes security vulnerability.

Moreover, when a problem occurs in the external cloud server, the local computer and IoT device may be uncontrollable, resulting in an unstable situation.

Meanwhile, when there is no cooperation between the application program development company and the IoT server development company, it is impossible to build a system for the local computer and IoT device.

Therefore, there is an urgent need to develop a new IoT device control system that can control IoT devices according to the progress of a local computer independently of an external cloud server.

### Document of Related Art

(Patent Document 1) Korean Patent Application Publication No. 10-2020-0075080

### SUMMARY OF THE INVENTION

Accordingly, the present disclosure has been made keeping in mind the above problems occurring in the related art, and the present disclosure is intended to control an IoT device according to the progress of a local computer independently of an external cloud server.

In addition, the present disclosure is intended to allow the IoT server to recognize the current situations of the local computer and the application program through searching for an image.

In addition, the present disclosure is intended to recognize the situation of the local computer by examining a location and an RGB value of each pixel of the local computer.

In order to achieve the objectives of the present disclosure, there is provided an IoT device control system having an IoT server, a local computer, and IoT devices networked through a router, the IoT device control system including: a local computer having an operating system and one or more application programs installed therein; and an IoT server configured to receive a predetermined mode command which defines operating situations of the local computer and an IoT device and to transmit a control command to the local computer and the IoT device so that the local computer and the IoT device are executed as defined in the received mode command, wherein the IoT device includes one or more IoT devices driven by the control command received from the IoT server.

In addition, the IoT device control system of the present disclosure may further include: an administrator computer which forms a network with the IoT server, the local computer, and the IoT device through a router, and transmits the predetermined mode command to the IoT server.

In addition, the IoT server of the present disclosure may search for a screen image of the local computer to recognize a current situation of the local computer, and transmit a control signal corresponding to the recognized current situation to the local computer and the IoT device to control the local computer and the IoT device in order to execute the received mode command.

In addition, in the present disclosure, the situation recognition through the searching for the screen image of the local computer may be determined by comparing a location and an RGB value of each pixel of the local computer with a location and an RGB value of the pixel for each situation which are preset.

In addition, the application program of the present disclosure may be a golf simulation program, and the IoT device may be an environmental facility required for operating the golf simulation program.

According to the IoT device control system based on searching for an image of the present disclosure, information is prevented from being exposed outside a local network.

In addition, according to the present disclosure, the IoT device control system operates independently of an external cloud server, thereby increasing the stability of the control system.

In addition, according to the present disclosure, it is possible to build a control system for controlling IoT devices without the help of an application developer.

In addition to the effects described above, the specific effects of the present disclosure will be described together with the specific details for embodying the present disclosure below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a drawing illustrating an IoT device control system that is linked with a conventional external cloud server; and

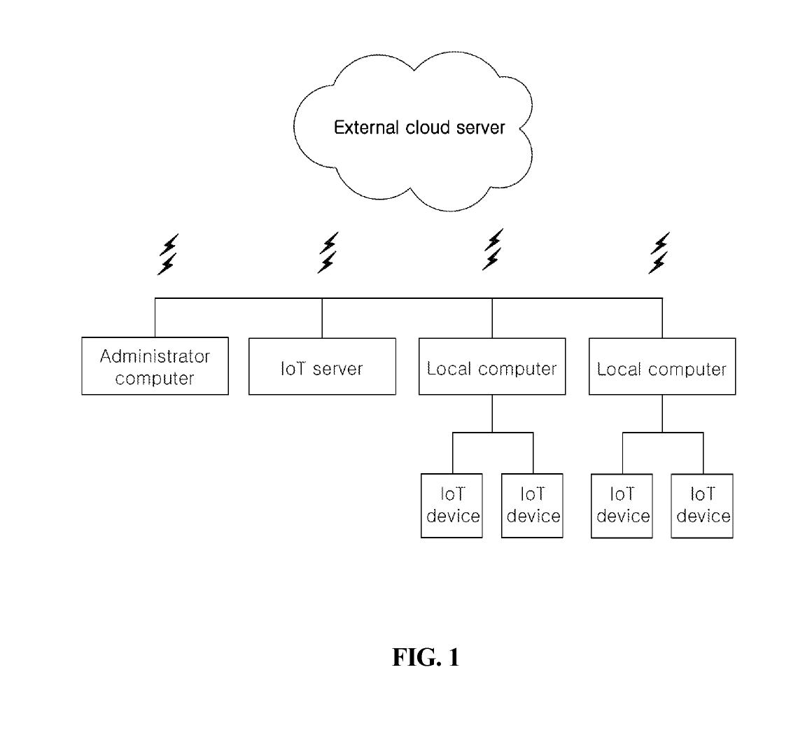

FIG. 2 is a drawing illustrating an IoT device control system based on searching for an image according to the present disclosure.

### DETAILED DESCRIPTION OF EXEMPLARY EMBODIMENTS

Hereinafter, the embodiment of the present document will be described with reference to the accompanying drawings. However, this is not intended to limit the technology described in this document to a specific embodiment, and it should be understood that various modifications, equivalents, and/or alternatives of the embodiment of this document are included. In connection with the description of the drawings, like reference numerals may be used for like components.

In addition, expressions such as "first" and "second" used in this document may modify various elements regardless of order and/or importance, and are used only to distinguish one element from another element but do not limit the corresponding components. For example, “first part” and “second part” may represent different parts regardless of order or importance. For example, without departing from the scope of the claims described in this document, the first component may be named as the second component, and similarly, the second component may also be named as the first component.

In addition, terms used in this document are used only to describe a specific embodiment, and may not be intended to limit the scope of other embodiments. A singular expression may include a plural expression unless the context clearly dictates otherwise. Terms used herein, including technical or scientific terms, may have the same meanings as commonly understood by those skilled in the art described in this document. Among the terms used in this document, terms defined in a general dictionary may be interpreted to have the same or similar meaning as meaning in the context of the related art, and unless explicitly defined in this document, are not interpreted as deal or excessively formal meanings. In some cases, even terms defined in this document cannot be construed to exclude the embodiment of the present document.

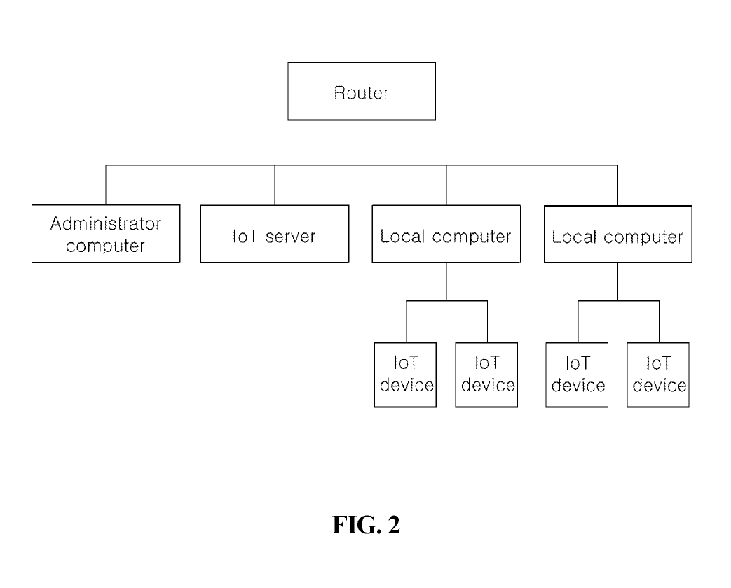

FIG. 2 is a drawing illustrating an IoT device control system based on searching for an image according to the present disclosure.

The following description will be made with reference to FIG. 2.

The IoT device control system according to the present disclosure includes an administrator computer, an IoT server, a local computer, and an IoT device, wherein the IoT device is controlled according to the execution situation of an application program installed on the local computer.

The administrator computer, the IoT server, the local computer, and the IoT device form a network through a router.

An operating system and one or more application programs are installed on the local computer.

The control system controls the local computer, the application program, and the IoT device in a predetermined manner for each situation. In this specification, each situation defined in the control system is defined as a “mode”.

The administrator computer is configured to transmit a predetermined mode command to the IoT server.

The IoT server receives the predetermined mode command that defines the operating situations of the local computer, the application program, and the IoT device, and transmits a control command to the local computer and the IoT device so that the local computer and the IoT device are executed as defined in the received mode command.

Depending on an environment in which the system is built, an administrator may be able to directly enter the mode command into the IoT server without going through the administrator computer.

In addition, depending on an environment in which the system is built, there may be one IoT server in the control system or one IoT server for each local computer. The IoT server may be physically installed independently outside the local computer or installed inside the local computer.

The IoT device is driven by the control command received from the IoT server, and includes one or more IoT devices.

In order for the IoT server to control the IoT device, the IoT server is required to recognize the current situations of the local computer and the application program so that the IoT server may transmit the corresponding control command to the IoT device.

In order to improve security issues and system instability resulting from interconnection between a conventional external cloud server, the local computer, and the IoT device, the present disclosure proposes a method of recognizing the current situations of the local computer and the application program independently of an external cloud server.

To this end, the present disclosure adopts a screen image recognition method.

The IoT server searches for a screen image of the local computer to recognize the current situation of the local computer, and transmits a control signal corresponding to the recognized current situation to the local computer and the IoT device to control the local computer and the IoT device in order to execute the received mode command.

The situation recognition through searching for the screen image of the local computer is determined by comparing a location and an RGB value of each pixel of the local computer with a location and an RGB value of the pixel for each situation which are preset.

That is, after saving an image for each situation, the pixel locations and RGB values of a currently searched image and the previously saved image for each situation are compared to accurately recognize the current situation.

The IoT device control system according to the present disclosure may be applied to various fields.

For the sake of understanding, it is briefly described that the IoT device control system according to the present disclosure is applied to a screen golf practice facility, but it is clear that the IoT device control system is not limited thereto and may be applied to various fields.

Referring to FIG. 2, in a screen golf facility, a network is formed between the administrator computer, the IoT server, and two local computers through the router.

The local computer has a golf simulation program installed as the application program, and IoT devices such as a beam projector, a heating and cooling device, and lights are installed near the local computer and are connected to the network.

The mode command may define, for example, a start-of-work mode, a practice mode, a match mode, an exit mode, and an end-of-work mode.

The start-of-work mode refers to a situation in which an administrator arrives at work and turns on a computer and a light.

When the IoT server receives a start-of-work mode command from the administrator computer, the IoT server recognizes that the screen of the local computer is off, and transmits a control command to the local computer and a lighting device to turn on the computer and the lighting device.

The practice mode is a mode for practicing swings before the match mode in which scores are calculated.

When the IoT server receives a practice mode command from the administrator computer, the IoT server searches for the screen image of the local computer.

When the screen image is identified to be an operating system screen, this indicates that the golf simulation program has not been executed yet, so the golf simulation program is executed. In addition, when the golf simulation program is in a standby situation in the screen image, the golf simulation program is controlled to enter a practice stage.

In addition, the IoT server operates the heating and cooling device defined in the practice mode at a preset temperature.

Accordingly, when the IoT device is required to be controlled according to the execution situation of the application program, the IoT device control system according to the present disclosure searches for the screen image of the local computer to recognize the situation, and then controls the local computer and the IoT device according to the situation.

By enabling the situation recognition through searching for the screen image of the local computer, there is no need to be connected with a separate external cloud server, thereby further enhancing security and improving system stability.

Furthermore, from the perspective of a developer of the IoT server, there is an advantage in that the developer of the IoT server is capable of building the control system independently without the need for cooperation with a developer of the application program.

In the above, the exemplary embodiment of the present disclosure has been illustrated and described, but the present disclosure is not limited to the specific embodiment described above. Various modifications of the embodiment may be made by those of ordinary skill in the technical field to which the invention belongs without departing from the gist of the present disclosure claimed in the claims. These modified embodiments should not be individually understood from the technical spirit or prospect of the present disclosure.

What is claimed is:

1. An IoT device control system having an IoT server, a local computer, and IoT devices networked through a router, the IoT device control system comprising:
a local computer having an operating system and one or more application programs installed therein; and
an IoT server configured to receive a predetermined mode command which defines operating situations of the local computer and an IoT device and to transmit a control command to the local computer and the IoT device so that the local computer and the IoT device are executed as defined in the received mode command,
wherein the IoT device includes one or more IoT devices driven by the control command received from the IoT server.

2. The IoT device control system of claim 1, further comprising:
an administrator computer which forms a network with the IoT server, the local computer, and the IoT device through a router, and transmits the predetermined mode command to the IoT server.

3. The IoT device control system of claim 1, wherein the IoT server searches for a screen image of the local computer to recognize a current situation of the local computer, and transmits a control signal corresponding to the recognized current situation to the local computer and the IoT device to control the local computer and the IoT device in order to execute the received mode command.

4. The IoT device control system of claim 3, wherein the situation recognition through the searching for the screen image of the local computer is determined by comparing a location and an RGB value of each pixel of the local computer with a location and an RGB value of the pixel for each situation which are preset.

5. The IoT device control system of claim 4, wherein the application program is a golf simulation program, and the IoT device is an environmental facility required for operating the golf simulation program.
